(19) United States
(12) Patent Application Publication
(10) Pub. No.: US 2003/0030618 A1
(43) Pub. Date: Feb. 13, 2003

(54) METHOD AND APPARATUS FOR SENSING CHANGES IN DIGITAL VIDEO DATA

(76) Inventor: MORRIS JONES, SARATOGA, CA (US)

Correspondence Address: David B. Ritchie, Thelen Reid & Priest LLP, PO Box 640640, San Jose, CA, 95164, US

(21) Appl. No.: 09/258,551

(22) Filed: Feb. 26, 1999

(51) Int. Cl. G09G 3/36

(52) U.S. Cl. 345/102

(57) ABSTRACT

A method and apparatus for sensing changes in digital video data includes a display control device which includes a video data interface, a detector and a controller. The video data interface receives digital video data. The detector determines whether image data is static by calculating the CRC of digital video data. The controller generates control signals in response to the detection of static digital video data. The controller may be coupled to one or more devices, including the backlight of a video display device. The backlight may be turned off when static data is detected. The backlight may be turned on again when non-static data is detected. Efficient power management is provided by controlling the state of a device based upon digital video data content.

### BACKGROUND OF THE INVENTION

1. Field of the Invention

The present invention relates to visual display devices, such as liquid crystal display (LCD) devices, that are used in computers and communication devices. More particularly, the present invention relates to a method and apparatus for sensing changes in digital video data.

2. Background

One important feature of computers and communication devices is power consumption. It is desirable to maximize the amount of usage between battery charges. Reducing power consumption increases the amount of usage between battery charges. Visual display devices, particularly the backlights included in many visual display devices, represent a significant portion of power consumption in computers and communication devices. Power consumption may be reduced by turning off devices such as a display backlight when video being sent to the video display is static.

A typical visual display device includes a video controller, which delivers control signals to a display panel, such as a LCD panel, according to control instructions from a processor, to commence the control of the display panel. The visual display device also stores character code data fed from the processor in a memory. The stored data are successively read from the memory, converted by the video controller to data to be displayed and sent to the display panel for display. The data is sent to the screen many times per second to refresh the screen.

As mentioned above, power consumption may be reduced by turning units of a computer off when the video data being sent to the video display is static. Typical methods for detecting static video data store all or part of consecutive images and then compare the data stored for each image. If the data stored for consecutive images is the same for a predetermined number of images, devices are placed into a low power consumption mode.

These methods have several disadvantages. Methods that compare the entire contents of successive images require an excessive amount of memory. Methods that compare only a portion of successive images fail to detect changing data in the image portions not compared. This may result in a device being turned off or on prematurely, possibly resulting in the loss of information.

Other typical methods check for changing video data in the computer processor, before the video data is sent to an external video display apparatus. This prevents power management of the display apparatus and any associated devices independent of the microprocessor.

Still other methods include comparing pulse trains in response to transitions in input video signals. These methods suffer from the disadvantage of requiring additional hardware circuitry at added cost. These methods also typically work with a specific type of visual display device. A need exists in the prior art for a method and apparatus for sensing changes in digital video data, which can sense changes independent of the microprocessor, and which requires minimal memory and hardware circuitry.

### BRIEF DESCRIPTION OF THE INVENTION

The present invention provides a method and apparatus for sensing changes in digital video data. A display control device includes a video data interface, a detector and a controller. The video data interface receives video data. The detector determines whether image data is static by calculating the Cyclic Redundancy Check (CRC) of digital video data. The controller generates control signals in response to the detection of static digital video data.

According to one embodiment, the controller is coupled to the backlight of a video display device. The backlight may be turned off when static data is detected. The backlight may be turned on again when non-static data is detected. Alternatively, the controller may be coupled to other devices, which are turned on or off depending upon the signals generated by the detector, thus providing efficient power usage.

### BRIEF DESCRIPTION OF THE DRAWINGS

FIG. 1 is a block diagram of a typical computer system including a display device.

FIG. 2 is a block diagram of a video display interface in accordance with an embodiment of the present invention.

FIG. 3A is a block diagram of a frame typically used on a thin film transistor (TFT) liquid crystal display.

FIG. 3B is a block diagram illustrating a 256-frame cycle in a typical frame rate control (FRC) super twisted nematic (STN)-type liquid crystal display.

FIG. 4 is a flow diagram of a method for detecting changes in digital video data in accordance with one embodiment of the present invention.

FIG. 5 is a flow diagram of a method for turning a video display backlight on an off in accordance with one embodiment of the present invention.

FIG. 6 is a block diagram of a video display interface for a super twisted nematic (STN) liquid crystal display in accordance with one embodiment of the present invention.

FIG. 7 is a block diagram of a video display interface for a dual scan super twisted nematic (DSTN) liquid crystal display in accordance with one embodiment of the present invention.

FIG. 8 is a block diagram of a video display interface for a thin film transistor (TFT) liquid crystal display in accordance with one embodiment of the present invention.

FIG. 9 is a flow diagram of a method for determining the cyclic redundancy check (CRC) of a video image for a super twisted nematic (STN) liquid crystal display in accordance with one embodiment of the present invention.

FIG. 10 is a flow diagram of a method for determining the CRC of a video image for a dual scan super twisted nematic (DSTN) liquid crystal display in accordance with one embodiment of the present invention.

FIG. 11 is a flow diagram of a method for determining the cyclic redundancy check (CRC) of a video image for a thin film transistor (TFT) liquid crystal display in accordance with one embodiment of the present invention.

### DETAILED DESCRIPTION OF THE PREFERRED EMBODIMENTS

Those of ordinary skill in the art will realize that the following description of the present invention is illustrative only. Other embodiments of the invention will readily suggest themselves to such skilled persons having the benefit of this disclosure.

The invention relates to visual display devices, such as liquid crystal display (LCD) devices, that are used in computers and communication devices. More particularly, the present invention relates to a method and apparatus for sensing changes in digital video data.

The invention further relates to machine readable media on which are stored (1) the layout parameters of the present invention and/or (2) program instructions for using the present invention in performing operations on a computer. Such media includes by way of example magnetic tape, magnetic disks, optically readable media such as CD ROMs and semiconductor memory such as PCMCIA cards. The medium may also take the form of a portable item such as a small disk, diskette or cassette. The medium may also take the form of a larger or immobile item such as a hard disk drive or a computer RAM.

Portable computers typically contain a flat panel display (FPD). A liquid crystal display (LCD) is one type of FPD. LCDs include the active matrix type, which are also called TFT (thin film transistor), and the passive matrix type, which are also called STN (super twisted nematic). Dual scan STN displays (DSTN) are divided into top and bottom panels and are scanned simultaneously from upper panel and lower panel data streams. Both TFTs and STNs are available in monochromatic or color versions. These FPDs are driven by a controller, which is usually part of an integrated circuit chip. The controller is often referred to as a display controller, or an LCD controller.

Analog gray scales are possible on TFTs. However, analog drive techniques are not available on STN LCDs because the voltage difference between on and off states is small, and thus difficult to control. Spatial and temporal techniques are used to control gray scales on this type of display.

One spatial technique used for LCDs is “dithering”. Since LCDs cannot vary the size of an individual dot, groups of dots are used. Dark areas of the image contain a higher proportion of black pixels, while lighter areas of the image contain a lower proportion of black pixels.

Temporal techniques used by many STN LCDs modulate the amount of time a pixel is on and off. These techniques take advantage of the fact that the human eye can only discern discrete frames at approximately 10 frames per second. A pixel element is either on or off. Full color shades are achieved by leaving the pixel “on” or “off” at all times. Partial color shades are achieved by turning the pixel “on” part of the time and “off” the rest of the time so that the eye perceives a shade that is somewhere between the highest intensity shade and the lowest intensity shade.

The temporal technique used widely with STN LCDs is referred to as Frame Rate Cycling or Frame Rate Control (FRC). This technique uses the frame refresh period as the smallest time interval. The number of frames defines the temporal sequence. In a two-frame FRC algorithm, two phases control the temporal sequence. Phase-1 is “on” during frame-1 and “off” during frame-2, while phase-2 is 180 degrees out of phase, or “off” during frame-1 and “on” during frame-2. By using two frames for the gray scale period, three shades may be produced, as shown in Table 1, below.

TABLE 1

| Frame | Shade |
|---|---|
| 0/2 | 0% |
| 1/2 | 50% |
| 2/2 | 100% |

Likewise, by using three frames for the gray scale period, four shades may be produced, as shown in Table 2, below. Thus, n shades requires using n-1 frames for the gray scale period.

TABLE 2

| Frame | Shade |
|---|---|
| 0/3 | 0% |
| 1/3 | 33% |
| 2/3 | 66% |
| 3/3 | 100% |

If the FRC technique and dithering/spatial techniques are combined, the number of gray scales may be extended beyond those produced by FRC or dithering alone.

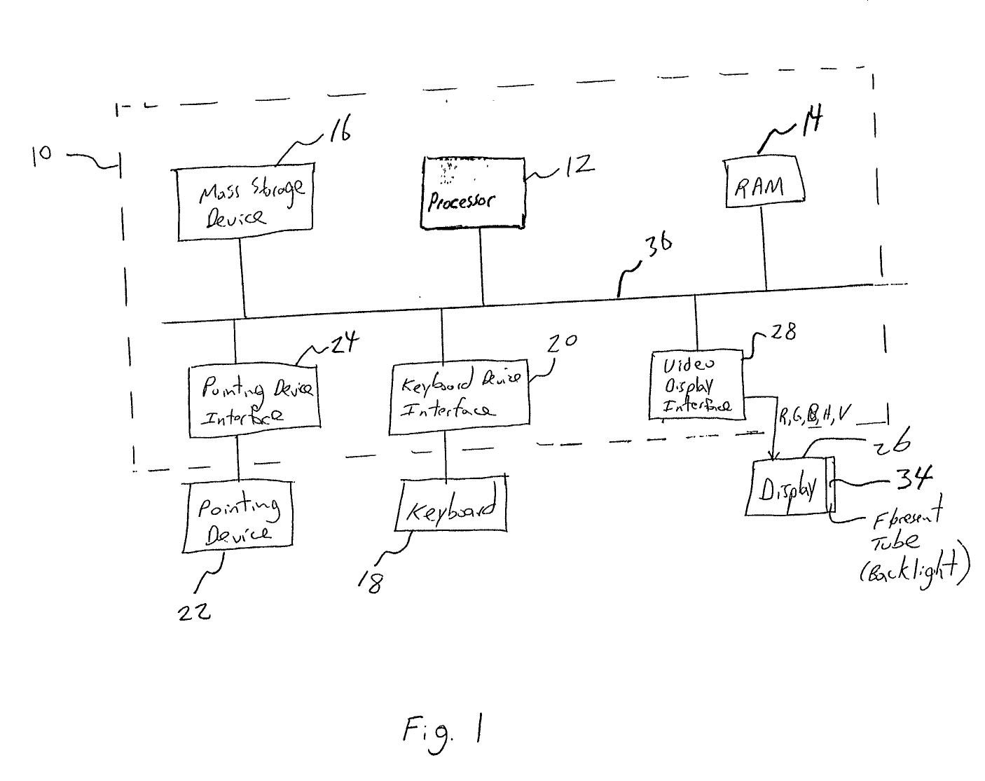

FIG. 1 is a block diagram showing a computer system according to one embodiment of the present invention. The computer system comprises a core unit 10, including a processor 12, a random access memory (RAM) 14, a mass storage device 16, a pointing device interface 24 and a keyboard device interface 20, all connected via a bus 36. A keyboard 18 is connected to the core unit 10 via the keyboard interface 20. A pointing device 22 is connected to the core unit 10 via the pointing device interface 24. The core unit 10 is also connected to a display device 26 via a video display interface 28. The display device 26 may be a LCD, such as a TFT, STN, or DSTN. The display device 26 contains a backlight 34.

In operation, the processor processes program instructions stored in RAM 14 and mass storage device 16. The pointing device interface 24 and the keyboard device interface 20 allow manually entered data via the pointing device 22 and the keyboard 18, respectively. The video display interface 28 accepts digital video data from the processor 12. The video display interface 28 puts the digital video data in a format acceptable to the display device 26. The video display interface 28 contains a display control device.

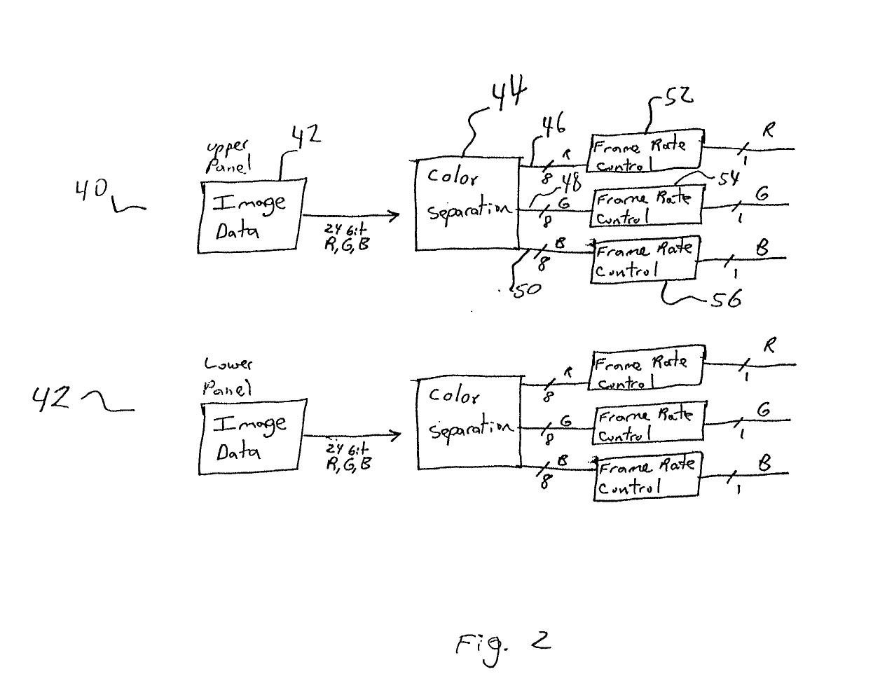

The video display interface for a DSTN LCD is structured as shown in FIG. 2. Unlike STN LCDs, DSTN LCDs are separated into an upper half and a lower half, and video data is processed separately, by 40 and 42. For the purposes of illustration, the invention will be described with respect to the upper half. The video display interface receives image data from the core unit 10 and stores it in a buffer 42. According to one embodiment, 24-bit red, green and blue (RGB) image data is received in the buffer 42. The buffer 42 is connected to a color separator 44, which separates the 24-bit RGB color data into eight-bit R 46, G 48 and B 50 components.

The eight-bit R 46, G 48 and B 50 data are inputted to frame rate control units 52, 54 and 56, respectively. The same image data is inputted from the color separator 44 256 consecutive times, and the respective frame rate control units 52, 54 and 56 perform frame rate modulation for the inputted image data. One cycle comprises 256 frames. Each frame rate control unit 52, 54 and 56 outputs different frame data each time as frame data for each color, depending upon the particular frame number.

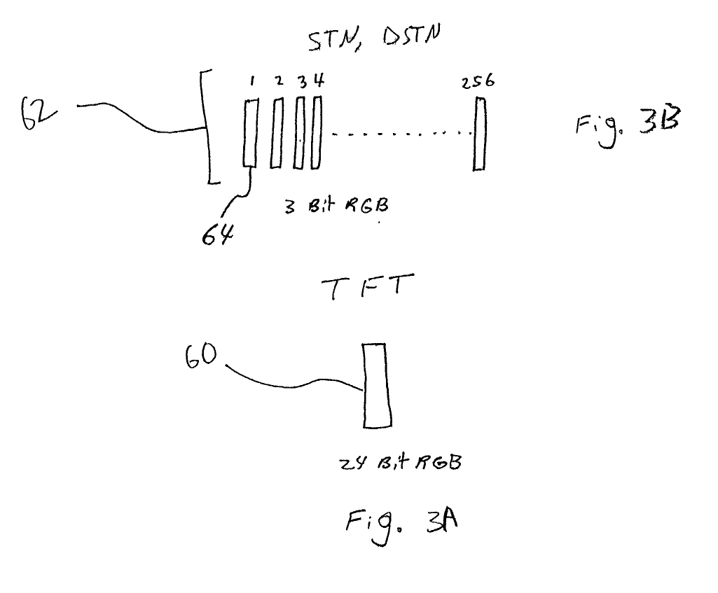

Referring now to FIG. 3A, a single frame containing 24-bit RGB color data is illustrated. 24-bit RGB data is commonly used with TFT-type LCD displays. The video data for one complete image is contained in one frame 60. The frame 60 contains separate 8-bit R, G and B components for every pixel in the image. Detecting a change between images is accomplished by comparing the CRCs for successive single frames.

Referring now to FIG. 3B, a 256-frame modulated cycle is illustrated. Frame modulated cycles are commonly used with STN or DSTN-type LCD displays. In a 256-frame cycle 62, the video data for one complete image is contained in 256 separate video frames 64. Therefore, detecting a change between images requires the comparison of 256 frames (one cycle 62) with another 256 frames. This comparison is done by comparing the Cyclic Redundancy Check (CRC) result of each set of 256 frames.

As indicated above, the present invention employs CRCs to detect changes between video images. To facilitate understanding the inventive concepts in the present invention, an overview of some aspects of the CRC algorithm will now be presented. The CRC algorithm provides a way of detecting small changes in blocks of data. The algorithm operates on a block of data as a unit. This block of data is divided by a number, referred to as the generator polynomial, leaving the remainder, which is the CRC result.

Generator polynomials are classified by their highest non-zero digit, which is termed the degree of the polynomial. A generator polynomial of degree n has n+1 bits and produces an n-bit CRC result. CRC generator polynomials are designed and constructed for use over data blocks of limited size. For n-bit generator polynomials, the maximum designed data length is generally 2⁽ⁿ⁻¹⁾−1 bits. The minimum degree generator polynomial required to detect an single bit change in an entire screen is shown in Table 3 below. The third entry in the table indicates the required polynomial degree to check all 256 frames of a 256 frame FRC modulated DSTN display image having a resolution of 1,024×768 (256 frames×3 bits per pixel=768 bits per pixel). The number of bits required is found by taking the logarithm of the number of bits in the image.

TABLE 3

| | | | Bits Per | Bits Per | | Display |
|---|---|---|---|---|---|---|
| | Horizontal | Vertical | Pixel | Image | LN2(Bits) | Type |
| 1 | 1,024 | 768 | 3 | 2,359,296 | 21.2 | DSTN |
| 2 | 1,024 | 768 | 24 | 18,874,368 | 24.2 | TFT |
| 3 | 1,024 | 768 | 768 | 6.04E + 08 | 29.2 | DSTN all |

According to one embodiment of the present invention, two 30-bit CRC registers are used to detect changing image data. Those of ordinary skill in the art will recognize that a register having the number of bits indicated in Table 3 will detect any single bit change in the indicated screen image. Furthermore, the addition of one parity bit enables detection of odd bit changes on the whole screen image. If a 30-bit CRC is used for entry number 3 in Table 3, the probability of two screen images having the same anomaly approximates 2⁻³¹. This probability is reduced further by using two registers instead of one. Thus, if two 30-bit CRCs are used, the probability of two screen images having the same anomaly becomes 2⁻⁶³.

According to another embodiment of the present invention, one 59-bit CRC is used. Using one 59-bit CRC for the same data requires a generator polynomial of order 59 as well.

According to a preferred embodiment of the present invention, a plurality of CRCs are used, each having a different lengths and cycles. This allows for maximum coverage. Additionally, all CRC registers are initialized to non-zero values, such as all ones. This is done because when a CRC register contains only zeros, processing a zero data bit does not change the CRC remainder. If the CRC register is clear, and extraneous zero bits occur, these data differences will not be detected. Initializing the CRC register to all ones before determining the CRC avoids this problem and allows the detection of extraneous leading zeros.

According to another embodiment of the present invention, two 30-bit CRC registers are used to detect changing image data, and the generator polynomials are x²⁸+x¹⁵+1 and x²⁹+x²⁷+1. The polynomial coefficients for each generator polynomial may be represented in hexadecimal format as x10008001 and x28000001, respectively. Both generator polynomials are primitive polynomials having different lengths and cycles.

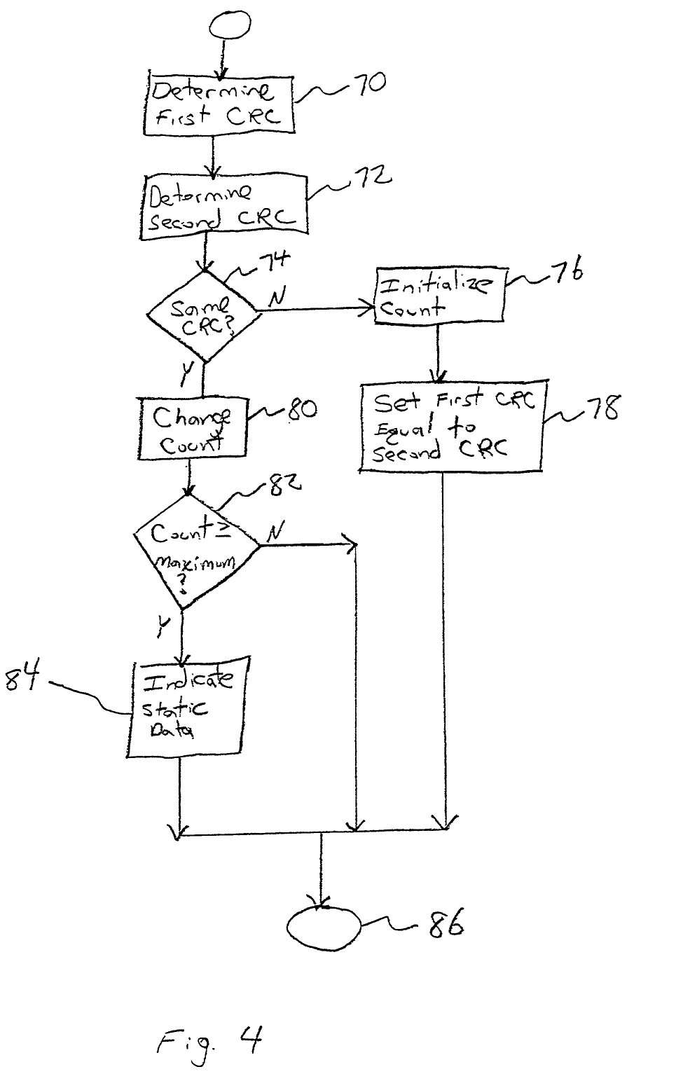

Turning now to FIG. 4, a method for detecting changing digital video data is presented. At reference numeral 70, the CRC for a first image is determined. At reference numeral 72, the CRC for a second CRC is determined. At reference numeral 74, the two CRCs are compared. If the CRCs are not the same, the count is initialized at reference numeral 76, and the first CRC value is set to the second CRC value at reference numeral 78.

If the CRCs are the same, a count is changed at reference numeral 88. If the count is initialized to a minimum value, the count would be incremented. If the count is initialized to a maximum value, the count would be decremented. At reference numeral 82, a check is made to determine whether a predetermined number of consecutive static images has been detected. If the predetermined number of static images has been detected, an indication of static data is made at reference numeral 84. If the predetermined number has not been detected, execution continues at reference numeral 86.

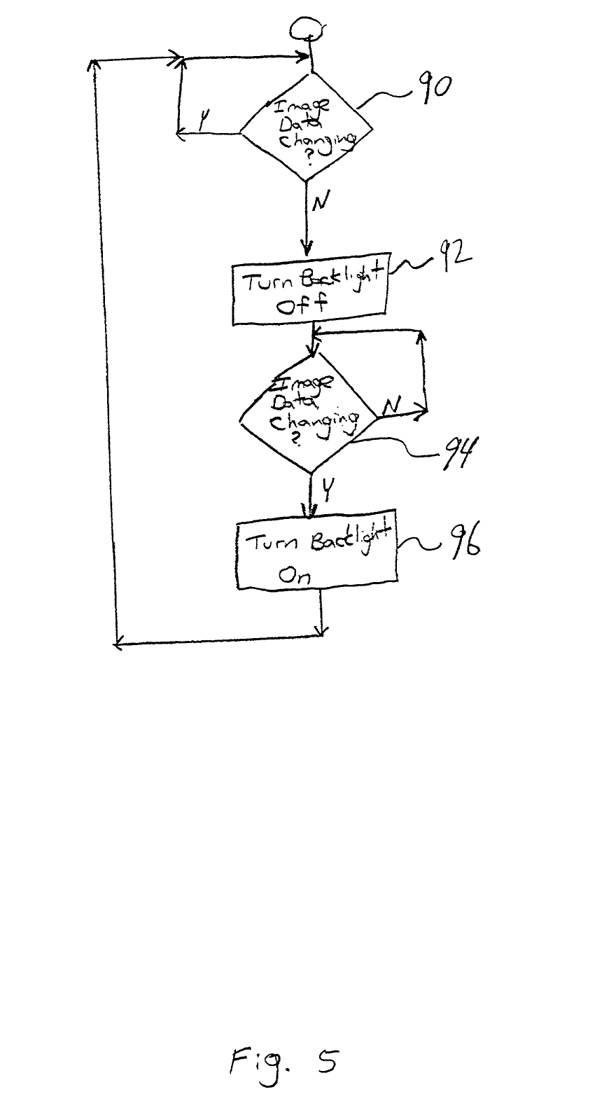

According to one embodiment of the present invention, the backlight 34 is turned off when static image data is detected for a predetermined number of frames. When image data starts changing again, the backlight 34 is turned back on. This method is shown in FIG. 5. At reference numeral 90, a check is made to determine whether image data is changing. If image data is changing, execution continues at reference numeral 90. If image data is not changing, the backlight 34 is turned off at reference numeral 92. At reference numeral 94, a check is made to determine whether image data is changing. If image data is not changing, execution continues at reference numeral 94. If image data is changing, the backlight 34 is turned on once again at reference numeral 96. After the backlight 34 is turned on, execution continues at reference numeral 90.

The description regarding turning the backlight 34 on and off based upon whether image data is changing is not intended to be limiting in any way. Those of ordinary skill in the art will readily recognize that the state of other devices may be changed upon the detection of static or changing image data. These changes might include turning a device on or off, or putting a device into or out of a “standby” mode.

According to another embodiment of the present invention, a portion of the screen image is excluded from the CRC determinations. This may be used to exclude portions of the image used to represent an item that changes over time, but is not of interest. Examples include a clock value or a flashing cursor. According to this embodiment, data is excluded from the CRC calculation by determining whether pixel data received is part of an exclusion region. If the data is part of an exclusion region, the data is not stored.

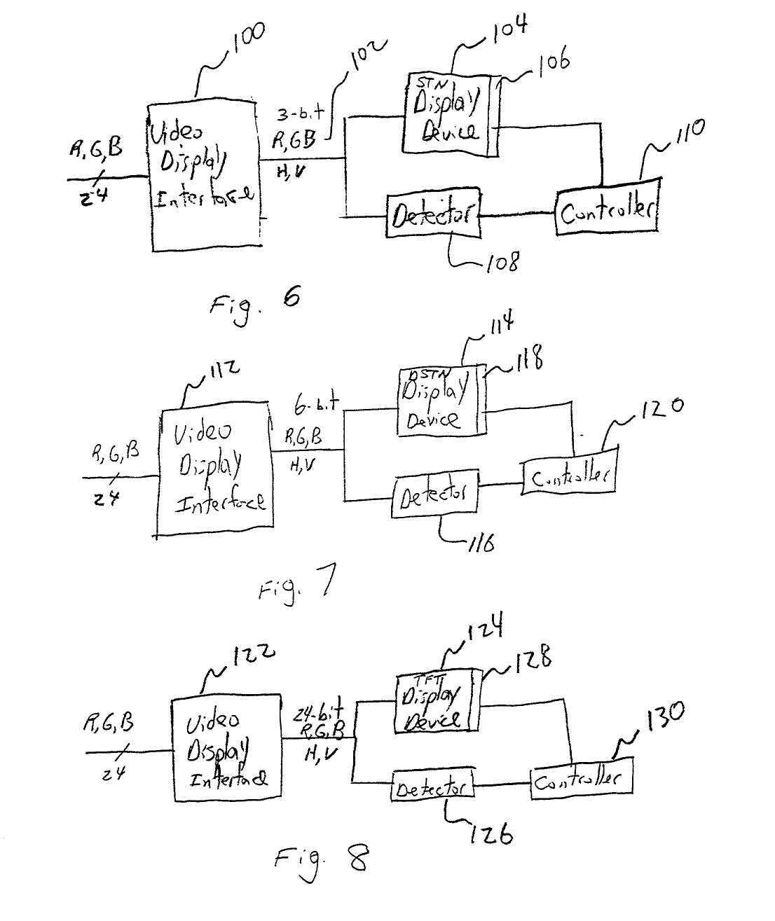

According to another embodiment of the present invention, the display device is an STN-type LCD. This is illustrated in FIG. 6. Twenty-four bit RBG data is received by the video display interface 100. Three-bit FRC modulated RGB data is output by the video display interface 100. A detector 108 determines whether digital video data is static. Upon sensing a change in the digital video data, controller 110 sends a signal to a device, which may include the backlight 106 of a display device 104.

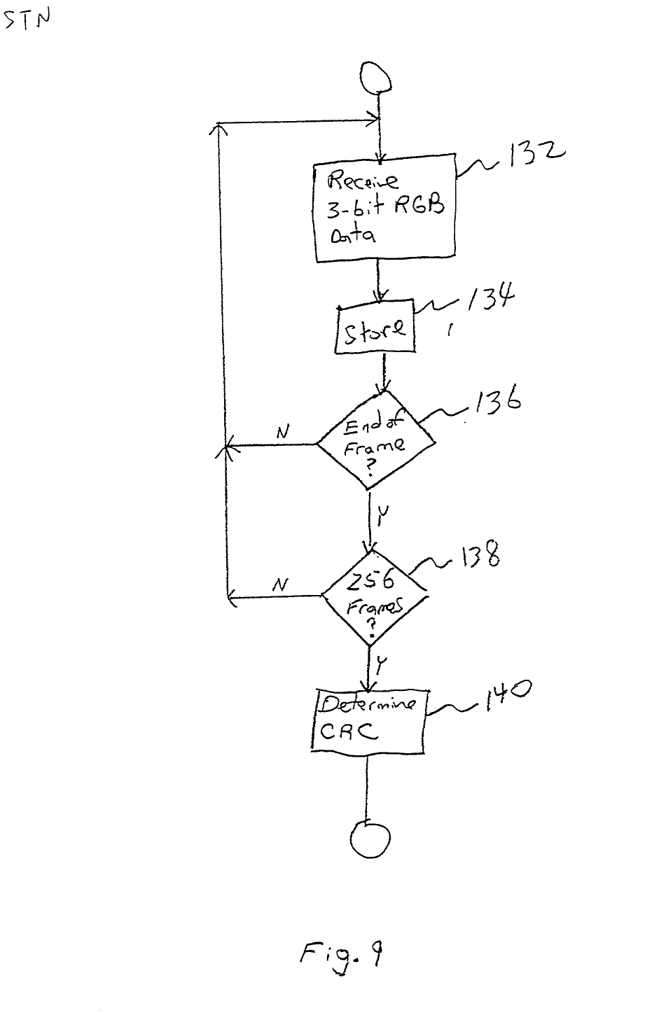

Turning now to FIG. 9, a method for detecting changing digital video data for a 256-frame FRC modulated STN-type LCD display is presented. At reference numeral 132, the detector 108 receives three bits of RGB data. At reference numeral 134, the data is stored. At reference numeral 136, a check is made to determine whether the end of a frame has been reached. If the end of a frame has not been reached, execution continues at reference numeral 132. If the end of a frame has been reached, a check is made to determine whether 256 frames have been read at reference numeral 138. If 256 frames have not been read, execution continues at reference numeral 138. If 256 frames have been read, the CRC for all 256 frames is calculated at reference numeral 140.

According to another embodiment of the present invention, the display device is a DSTN-type LCD. This is illustrated in FIG. 7. Twenty-four bit RBG data is received by the video display interface 112. Three-bit FRC modulated RGB data is output by the video display interface 112 for both the upper panel and the lower panel. A detector 116 determines whether digital video data is static. Upon sensing a change in the video data, controller 120 sends a signal to a device, which may include the backlight 118 of a display device 114.

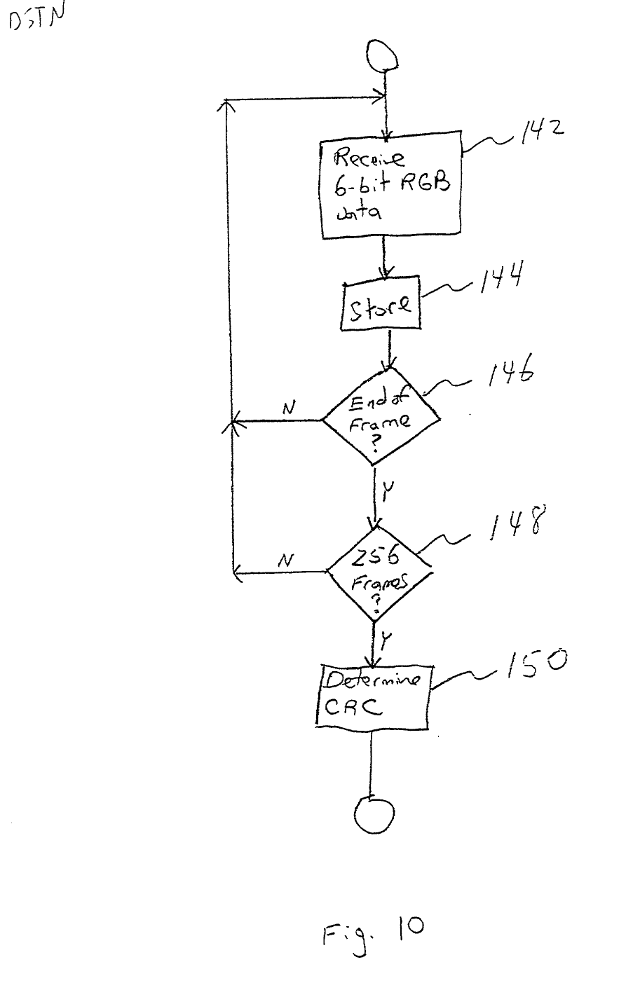

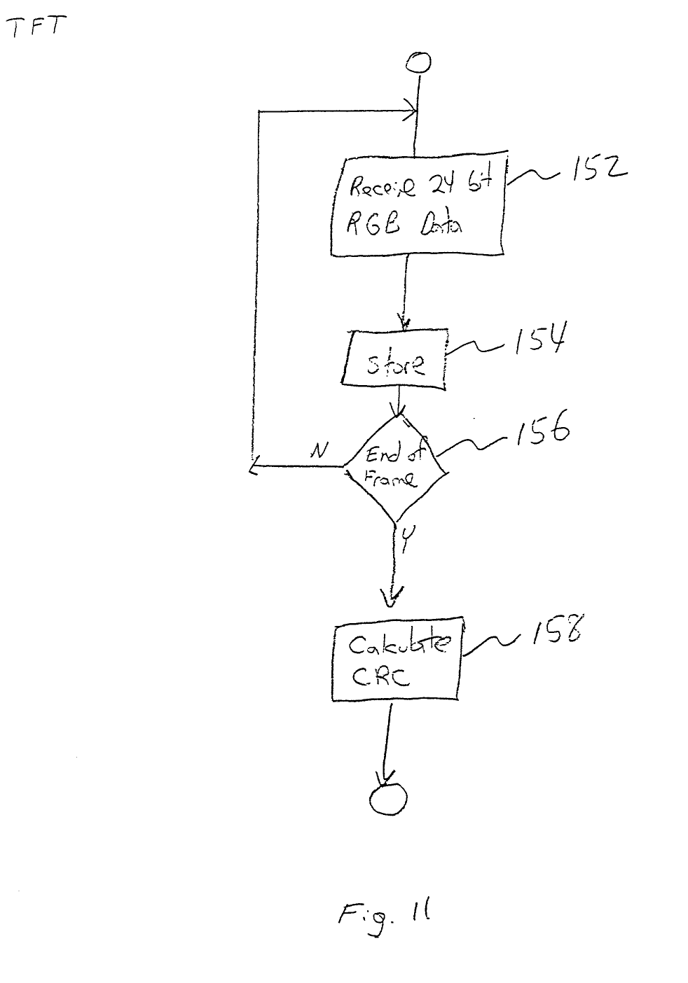

Turning now to FIG. 10, a method for detecting changing digital video data for a 256-frame FRC modulated DSTN-type LCD display is presented. At reference numeral 142, the detector 116 receives six bits of RGB data. Three of the six bits are from the upper half of the display and the other three bits are from the lower half of the display. At reference numeral 144, the bits from the upper and lower halves of the display are combined and stored. At reference numeral 146, a check is made to determine whether the end of a frame has been reached. If the end of a frame has not been reached, execution continues at reference numeral 142. If the end of a frame has been reached, a check is made to determine whether 256 frames have been read at reference numeral 148. If 256 frames have not been read, execution continues at reference numeral 142. If 256 frames have been read, the CRC for all 256 frames is calculated at reference numeral 150.

According to another embodiment of the present invention, the display device is a TFT-type LCD. This is illustrated in FIG. 8. Twenty-four bit RBG data is received by the video display interface 122. Twenty-four bit RGB data is output by the video display interface 122 for both the upper panel and the lower panel. A detector 126 determines whether digital video data is static. Upon sensing a change in the digital video data, controller 130 sends a signal to a device, which may include the backlight 128 of a display device 124.

Turning now to FIG. 11, a method for detecting changing digital video data for a TFT-type LCD display is presented. At reference numeral 152, the detector receives twenty-four bits of RGB data for one pixel. At reference numeral 154, the data is stored. At reference numeral 156, a check is made to determine whether the end of a frame has been reached. If the end of a frame has not been reached, execution continues at reference numeral 152. If the end of a frame has been reached, the CRC is calculated at reference numeral 158.

The above discussion of STN, DSTN and TFT displays is not intended to be limiting in any way. Those of reasonable skill in the art will recognize that the invention may be applied to other displays, including a MIN-type liquid crystal display or the like. The present invention may also be applied to a plasma display or the like. Additionally, the present invention may also be applied to a Cathode Ray Tube (CRT)-type display or its equivalent.

Moreover, the above discussion of 256 gray levels is not intended to be limiting in any way. Those of reasonable skill in the art will recognize that other gray scales may be used as well. Additionally, those of reasonable skill in the art will recognize that the invention may be applied to display devices employing other color spaces such as YUV, or to monochrome display devices. The invention may also be applied to display devices that employ a combination of spatial and temporal techniques to vary the possible number of grayscales.

According to a presently preferred embodiment, the present invention may be implemented in software or firmware, as well as in programmable gate array devices, ASIC and other hardware.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A display control device, comprising:
a video data interface for receiving video data;
a detector coupled to said video data interface, said detector to perform a CRC calculation on digital video data from said video data interface to determine when said digital video data is from a static image; and
a controller coupled to said detector to generate at least one control signal in response to a detection of static image data by said detector.

2. The display control device of claim 1 wherein said detector excludes from said CRC calculation any portion of the screen that contains a cursor.

3. The display control device of claim 2, further comprising at least one CRC register in said detector, said at least one CRC register initialized to zero at the beginning of each CRC determination.

4. The display control device of claim 3, wherein said at least one control signal generated by said controller is operatively coupled to the backlight of a display device.

5. The display control device of claim 4, further comprising CRC generator polynomials having different lengths, said CRC generator polynomials having different cycles.

6. The display control device of claim 5 wherein said digital video data is color video data.

7. The display control device of claim 6 wherein said at least one CRC register comprises two registers.

8. The display control device of claim 7 wherein each of said registers is 31 bits.

9. The display control device of claim 8 wherein said generator polynomials are x²⁸+x¹⁵+1 and x²⁹+x²⁷+1.

10. A computer system, comprising:
a bus;
a first processor coupled to said bus;
a second processor coupled to said bus, said second processor comprising
a video data interface for receiving video data;
a detector coupled to said video data interface, said detector to perform a CRC calculation on digital video data from said video data interface to determine when said digital video data is from a static image; and
a controller coupled to said detector to generate at least one control signal in response to a detection of static image data by said detector, said at least one control signal operatively coupled to at least one device;
a storage device coupled to said bus, said storage device to store video data sent to said second processor via said bus under the control of said first processor; and
a display coupled to said second processor, said display to display video data from said second processor.

11. The computer system of claim 10 wherein said detector excludes from said CRC calculation any portion of the screen that contains a cursor.

12. The computer system of claim 11, wherein said at least one control signal generated by said controller is operatively coupled to the backlight of a display device.

13. The computer system of claim 12, further comprising at least one CRC register in said detector, said at least one CRC register initialized to zero at the beginning of each CRC determination.

14. The computer system of claim 13, further comprising CRC generator polynomials having different lengths, said CRC generator polynomials having different cycles.

15. The computer system of claim 14 wherein said digital video data is color video data.

16. The computer system of claim 15 wherein said at least one CRC register comprises two registers.

17. The computer system of claim 16 wherein each of said registers is 31 bits.

18. The computer system of claim 17 wherein said generator polynomials are x²⁸+x¹⁵+1 and x²⁹+x²⁷+1.

19. A method for detecting static digital video data, comprising:
determining a first CRC by obtaining the CRC of a first video image;
determining a second CRC by obtaining the CRC of a second video image;
changing a count when said first CRC equals said second CRC;
initializing said count when said first CRC does not equal said second CRC;
setting said first CRC equal to said second CRC when said first CRC does not equal said second CRC; and
indicating detection of static data when a predetermined number of static images has been detected.

20. The method of claim 19 wherein
said initializing comprises setting said count to a minimum value;
said changing comprises adding one to said count; and
said detecting a predetermined number of static images has been detected comprises determining whether said count is greater than said predetermined number.

21. The method of claim 20 wherein
said initializing comprises setting said count to a maximum value;
said changing comprises subtracting one from said count; and
said determining whether a predetermined number of static images has been detected comprises determining whether said count is less than said predetermined number.

22. The method of claim 21 wherein
said CRC determinations exclude from the determination any portion of the screen that contains a cursor; and
CRC values are initialized to zero at the beginning of said CRC calculations.

23. The method of claim 22, further comprising:
turning a video display backlight off when said predetermined number of static images is detected; and
turning a video display backlight on when a minimum number of non-static images is detected.

24. The method of claim 23 wherein
said CRC generator polynomials have different lengths; and
said CRC generator polynomials have different cycles.

25. The method of claim 24 wherein said generator polynomials are x²⁸+x¹⁵+1 and x²⁹+x²⁷+1.

26. A program storage device readable by a machine, tangibly embodying a program of instructions executable by the machine to detect static digital video data, comprising:
a first module comprising code for causing a machine to determine a first CRC by obtaining the CRC of a first video image;
a second module comprising code for causing a machine to determine a second CRC by obtaining the CRC of a second video image;
a third module comprising code for causing a machine to change a count when said first CRC equals said second CRC;
a fourth module comprising code for causing a machine to initialize said count when said first CRC does not equal said second CRC;
a fifth module comprising code for causing a machine to set said first CRC equal to said second CRC when said first CRC does not equal said second CRC; and
a sixth module comprising code for causing said machine to indicate detection of static data when a predetermined number of static images has been detected.

27. The program storage device of claim 26 wherein
said CRC determinations exclude from the determination any portion of the screen that contains a cursor; and
CRC values are initialized to zero at the beginning of said CRC calculations.

28. The program storage device of claim 27, further comprising:
a seventh module comprising code causing a machine to turning a video display backlight off when said predetermined number of static images is detected; and
a eighth module comprising code for causing a machine to turning a video display backlight on when a minimum number of non-static images is detected.

29. The program storage device of claim 28 wherein
said CRC generator polynomials have different lengths; and
said CRC generator polynomials have different cycles.

30. The program storage device of claim 29 wherein said generator polynomials are x²⁸+x¹⁵+1 and x²⁹+x²⁷+1.
